(19) United States
(12) Patent Application Publication
(10) Pub. No.: US 2005/0020161 A1
(43) Pub. Date: Jan. 27, 2005

(54) Garment made from composite fabric for weather protection

(76) Inventor: Timothy Graeme Dummer, Landenberg, PA (US)

Correspondence Address: INVISTA NORTH AMERICA S.A.R.L., 4417 LANCASTER PIKE, CRP 722/1032, WILMINGTON, DE, 19805, US

(21) Appl. No.: 10/874,776

(22) Filed: Jun. 23, 2004

Related U.S. Application Data
(60) Provisional application No. 60/485,527, filed on Jul. 7, 2003.

(51) Int. Cl. B32B 27/04; B32B 27/12; D04H 1/00; B32B 5/02; D04H 3/00

(52) U.S. Cl. 442/104; 442/199; 442/286; 442/361; 442/394; 442/311; 428/373

(57) ABSTRACT

A waterproof, breathable, recyclable, layered composite fabric with stretch that is especially well-suited for weather protection garments and the like, has at least one layer of a woven, knitted, or non-woven face fabric of stretch-recovery bicomponent fibers, and an elastomeric waterproof film or coating of the same polymer, and optionally a liner fabric of knitted construction. The composite fabric is recyclable using traditional techniques to recycle polyester or polyamide. Garments made from this fabric are also disclosed.

### CROSS-REFERENCE TO RELATED APPLICATION

This application claims priority from U.S. Provisional application Ser. No. 60/485,527, filed Jul. 7, 2003.

### BACKGROUND OF THE INVENTION

1. Field of the Invention

This invention relates to a breathable fabric with stretch which is especially well suited for weather protection garments and the like. The composite fabric is substantially all polyester or all nylon and is recyclable. This invention also relates to a waterproof, breathable recyclable garment with stretch made from the disclosed fabric.

2. Description of Background Art

Waterproof breathable fabrics and the garments made from them are known. Disposable rain garments are disclosed in U.S. Pat. Nos. 4,783,856, 3,665,518, and 2,620,477. A flexible layered product suitable for use in rainwear or tents is disclosed in U.S. Pat. No. 4,493,870. A breathable, waterproof jacket is disclosed in U.S. Pat. No. 5,533,210. Breathable, waterproof jackets are commercially available from manufacturers such as Schoffel. The North Face, Patagonia, Columbia, and others.

Waterproof fabrics for raingear also may be designed to have stretch, such as disclosed in U.S. Pat. No. 4,761,324, published Japanese applications JP 2002-004176 A and JP 2002-004178 A, or as described for Schoeller-Stretchlight® fabric.

Driven by increasing concern about environmental pollution, considerable attention has been devoted in recent years to recycling waste products. The desire to recycle has extended to consumer products, including wearing apparel. Recyclable jackets have been disclosed in Sport Premiere Magazine (May 1993) and in U.S. Pat. No. 5,533,210. The Schoffel offering described in Sport Premiere Magazine is composed of two different polymers, and, while each polymer is recyclable, the two polymer components must be separated prior to recycling. This additional step adds expense and complexity to the recycling process. The jacket described in U.S. Pat. No. 5,533,210, while being recyclable, lacks the stretch desired in today's apparel for styling, comfort, fit, and freedom of movement.

There remains a need for a fabric which is waterproof yet breathable for dry comfort, which has stretch for ease and comfort of wearing, and which is also recyclable and therefore has minimal impact on the environment. Furthermore, there exists a need for weather-protection garments made from such fabric.

### SUMMARY OF THE INVENTION

In one aspect, the invention provides a recyclable, waterproof, breathable layered composite fabric with stretch that has at least one fabric layer of woven, knitted or non-woven construction comprising from 1% to 100% by weight of stretch-recovery polyester bicomponent fibers, and an elastomeric waterproof film or coating comprising polyester on or adjacent to said fabric layer. The layered composite fabric is sufficiently free of non-polyester components such that no separation step is required to recycle the layered composite fabric as a source of recyclable polyester. The fabric is recyclable because substantially all the layers forming the fabric are substantially comprised of the same polymer, polyester, and there is no need to separate the components in order to recycle the fabric. In this regard, the fabric can also include a small amount of auxiliary material and still be recyclable.

In another embodiment, the invention provides a recyclable, waterproof, breathable garment with stretch comprising the layered composite fabric of the invention in combination with one or more liner fabrics of knitted construction comprising polyester. The garment manufactured from the described fabric is also waterproof and breathable with stretch, and provides excellent weather protection while also being very comfortable to wear. With the appropriate film or coating, such garments could also be used to provide protection from microbes, such as viruses and bacteria. When substantially all parts of the garment, such as threads, seam tapes, laces, drawstrings, drawstring stops, fasteners, buttons, linings, insulation, pads, and optional other accessories are also comprised of polyester, the garment itself is recyclable with no need to separate its components for recycling. In this regard, the garment can also include a small amount of auxiliary material and still be recyclable.

The invention provides, in yet another embodiment, a recyclable, waterproof, breathable layered composite fabric with stretch, that has at least one fabric layer of woven, knitted or non-woven construction comprising from 1% to 100% by weight of stretch-recovery polyamide bicomponent fibers, and an elastomeric waterproof film or coating comprising polyamide on or adjacent to said fabric layer. The layered composite fabric of this embodiment is sufficiently free of non-polyamide components such that no separation step is required to recycle said layered composite fabric as a source of recyclable polyamide.

The invention further provides a recyclable, waterproof, breathable garment with stretch made with the layered composite polyamide fabric of the invention, in combination with a liner fabric of knitted construction comprising polyamide.

Further embodiments are envisioned where substantially all layers of the waterproof, breathable composite fabric with stretch are substantially comprised of one polymer type, and substantially all parts of the waterproof, breathable, garment with stretch are substantially comprised of one polymer type, preferably the same type as in the fabric. Being comprised substantially of one polymer type, these fabrics and garments would also be recyclable. Without being limiting, these polymer types could include polyolefins and polyurethanes, for example.

Recycling of the fabrics or garments disclosed herein can be done by depolymerization of the polymer into its monomeric components or by melting the polymer and reprocessing it. Processes for recycling polyester are disclosed, for example, in U.S. Pat. Nos. 5,051,528, 5,225,130, 6,056,901, and 6,472,557, and references therein. Processes for recycling polyamide are disclosed, for example, in U.S. Pat. Nos. 5,266,694, 5,302,756, 5,310,905, and 6,087,494, and references therein.

### DETAILED DESCRIPTION OF THE INVENTION

“Waterproof” as used herein refers to the ability to physically prevent water intrusion through a layer. Determination of resistance to water penetration of textile fabrics via a hydrostatic pressure test is described in the international standard test method ISO 811, “Waterproofness.”

As used herein, “breathable” refers to a film, coating, or layered composite fabric which is capable of transporting water vapor through its thickness. This can be achieved, for example, with a microporous structure, with a monolithic hydrophilic structure, or with a combination of the two. Determination of breathability is described in the international standard test method ISO 11092, “Textiles—Physiological Effects—Measurement of Thermal and Water-Vapour Resistance Under Steady-State Conditions (Sweating Guarded-Hotplate Test).”

“Layered composite fabric” as defined by the invention means that the completed fabric is comprised of at least two different fabric layers which have been laminated together or coated one onto the other. Preferably, the first fabric layer is a woven, knitted, or non-woven fabric of stretch recovery bicomponent fibers, and a second fabric layer is an elastomeric, waterproof breathable film or coating, substantially comprising the same polymer as the first fabric. Additional fabric layers optionally may be included in a layered composite fabric.

As used herein, “bicomponent fibers” means fibers in which two polymers of the same general class are in a side-by-side or eccentric sheath-core relationship, and includes both crimped fibers and fibers with latent crimp that has not yet been realized.

“Fibers” includes within its meaning continuous filaments and staple fibers.

The term “side-by-side” cross-section means that the two components of the bicomponent fiber are substantially aligned along their length and that no more than a minor portion of either component is within a concave portion of the other component.

The two polyesters of the polyester bicomponent used in the bicomponent effect yarn of the present invention can have different compositions, for example 2G-T (poly(ethylene terephthalate)) and 3G-T (poly(trimethylene terephthalate)) (preferred) or 2G-T and 4G-T (poly(butylene terephthalate)), and preferably have different intrinsic viscosities. Alternatively, the compositions can be similar, for example a poly(ethylene terephthalate) homopolyester and a poly(ethylene terephthalate) copolyester, optionally also of different viscosities.

One or both of the polyesters comprising the fiber of the invention can be copolyesters, and 2G-T or “poly(ethylene terephthalate)” and 3G-T or “poly(trimethylene terephthalate)” include such copolyesters within their meanings. For example, a copoly(ethylene terephthalate) can be used in which the comonomer used to make the copolyester is selected from the group consisting of linear, cyclic, and branched aliphatic dicarboxylic acids having 4-12 carbon atoms (for example butanedioic acid, pentanedioic acid, hexanedioic acid, dodecanedioic acid, and 1,4-cyclo-hexanedicarboxylic acid); aromatic dicarboxylic acids other than terephthalic acid and having 8-12 carbon atoms (for example isophthalic acid and 2,6-naphthalenedicarboxylic acid); linear, cyclic, and branched aliphatic diols having 3-8 carbon atoms (for example 1,3-propane diol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and aliphatic and araliphatic ether glycols having 4-10 carbon atoms (for example, hydroquinone bis(2-hydroxyethyl) ether, or a poly(ethyleneether) glycol having a molecular weight below about 460, including diethyleneether glycol). The comonomer can be present to the extent that it does not compromise the benefits of the invention, for example at levels of about 0.5-15 mole percent based on total polymer ingredients. Isophthalic acid, pentanedioic acid, hexanedioic acid, 1,3-propane diol, and 1,4-butanediol are preferred comonomers.

The copolyester(s) can also be made with minor amounts of other comonomers, provided such comonomers do not have an adverse affect on the wicking characteristics of the fiber. Such other comonomers include 5-sodium-sulfoisophthalate, the sodium salt of 3-(2-sulfoethyl) hexanedioic acid, and dialkyl esters thereof, which can be incorporated at about 0.2-4 mole percent based on total polyester. For improved acid dyeability, the (co)polyester(s) can also be mixed with polymeric secondary amine additives, for example poly(6,6′-imino-bishexamethylene terephthalamide) and copolyamides thereof with hexamethylenediamine, preferably phosphoric acid and phosphorous acid salts thereof.

Suitable homopolyamides include, but are not limited to, polyhexamethylene adipamide homopolymer (nylon 66); polycaproamide homopolymer (nylon 6); polyenanthamide homopolymer (nylon 7); nylon 10; polydodecanolactam homopolymer (nylon 12); polytetramethyleneadipamide homopolymer (nylon 46); polyhhexamethylene sebacamide homopolymer (nylon 610); the polyamide of n-dodecanedioic acid and hexamethylenediamine homopolymer (nylon 612); and the polyamide of dodecamethylenediamine and n-dodecanedioic acid homopolymer (nylon 1212). Copolymers and terpolymers for the monomers used to form the above-mentioned homopolymers are also suitable for the present invention.

Suitable copolyamides include, but are not limited to, copolymers of the monomers used to form the above-named homopolyamides. In addition, other suitable copolyamides include, for example, nylon 66 contacted and intimately mixed with nylon 6, nylon 7, nylon 10, and/or nylon 12. Illustrative polyamides also include copolymers made from dicarboxylic acid component, such as terephthalic acid, isophthalic acid, adipic acid, or sebacic acid; an amide component, such as polyhexamethyleneterephthalamide, poly-2-methylpentamethyleneadipamide, poly-2-ethyltetramethyleneadipamide, or polyhexamethyleneisophthalamide; a diamine component, such as hexamethylenediamine and 2-methylpentamethylenediamine; and 1,4-bis(aminomethyl)cyclohexane. Preferably, one component of the bicomponent yarn is a copolyamide of nylon 66 copolymerized with poly-2-methylpentamethyleneadipamide (MPMD). This copolyamide may be made by polymerizing adipic acid, hexamethylenediamine, and MPMD together. Most preferably, one component of the bicomponent yarn is a copolyamide of nylon 66 copolymerized with poly-2-methylpentamethyleneadipamide, and the second component is nylon 66.

There is no particular limitation on the outer cross-section of the bicomponent fiber, which can be round, oval, triangular, ‘snowman’ and the like. A “snowman” cross-section can be described as a side-by-side cross-section having a long axis, a short axis, and at least two maxima in the length of the short axis when plotted against the long axis.

The fibers of the present invention can also comprise or incorporate conventional additives such as antistats, antioxidants, antimicrobials, flameproofing agents, dyestuffs, light stabilizers, and delustrants such as titanium dioxide, provided they do not detract from the benefits of the invention.

Elastomeric films or coatings suitable for the present invention include those made from copolyetheresters and copolyetherester blends. These films and the resins for fabricating them are known and commercially available. Suitable copolyetheresters and copolyetherester blends are available from the E.I. DuPont de Nemours and Company, Wilmington, Del., USA. Suitable films may also be bi-layer or multi-layer.

Preferred copolyetheresters for fabricating the elastomeric film have a multiplicity of recurring long-chain ester units and short-chain ester units joined head-to-tail through ester linkages. The long-chain ester units are represented by the formula: 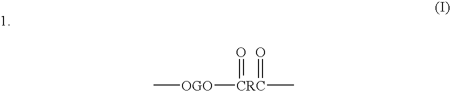
and the short-chain ester units are represented by the formula: 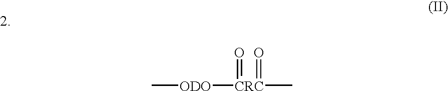
wherein:
a) G is a divalent radical remaining after the removal of terminal hydroxyl groups from a poly(alkylene oxide)glycol having an average molecular weight of about 400-3500, wherein the amount of ethylene oxide groups incorporated in said one or more copolyetheresters by the poly(alkylene oxide)glycol is from about 20 to about 68 weight percent, preferably from about 25 to about 68 weight percent, based upon the total weight of the copolyetherester(s);
b) R is a divalent radical remaining after removal of carboxyl groups from a dicarboxylic acid having a molecular weight less than about 300;
c) D is a divalent radical remaining after removal of hydroxyl groups from a diol having a molecular weight less than about 250;
wherein said copolyetherester(s) contain from about 25 to about 80 weight percent short-chain ester units.

It is preferred that said copolyetherester(s) have a moisture vapor transmission rate (MVTR) of at least about 2500, preferably at least about 3500, and more preferably from about 3500 to about 20000, gm.mil/m²/24 hrs according to ASTM E96-66 (Procedure BW).

As used herein, the term “ethylene oxide groups incorporated in the copolyetherester(s)” means the weight percent in the total copolyetherester(s) of (CH₂—CH₂—O—) groups in the long-chain ester units. The ethylene oxide groups in the copolyetherester that are counted to determine the amount in the polymer are those derived from the poly(alkylene oxide)glycol and not ethylene oxide groups introduced into the copolyetherester by means of a low molecular weight diol.

As used herein, the term “long-chain ester units” as applied to units in a polymer chain refers to the reaction product of a long-chain glycol with a dicarboxylic acid. Suitable long-chain glycols are poly(alkylene oxide)glycols having terminal (or as nearly terminal as possible) hydroxy groups and having a molecular weight of from about 400 to about 3500, particularly from about 600 to about 1500.

The poly(alkylene oxide)glycols used to make the copolyetheresters preferably should contain ethylene oxide groups in amounts that result in a copolyetherester having from about 20 to about 68, preferably from about 25 to about 68, more preferably from about 30 to about 55, weight percent ethylene oxide groups, based on the total weight of the copolyetherester. The ethylene oxide groups cause the polymer to have the characteristic of being readily permeable to moisture vapor and, generally, the higher the percentage of ethylene oxide in the copolyetherester, the higher degree of water permeability. Random or block copolymers of ethylene oxide containing minor portions of a second poly(alkylene oxide)glycol can be used. Representative long-chain glycols include poly(ethylene oxide)glycol, ethylene-oxide capped polypropylene oxide glycol, mixtures of poly(ethylene oxide)glycol with other glycols such as ethylene oxide capped poly(propylene oxide)glycols and/or poly(tetramethylene oxide)glycol provided the resulting copolyetherester has an amount of ethylene oxide groups of at least about 25 weight percent. Copolyetheresters prepared from poly(ethylene oxide)glycols having a molecular weight of from about 600 to 1500 are preferred because they provide a combination of superior moisture vapor permeability and limited water swell, and, when formed into a film, they exhibit useful properties over a wide temperature range.

The term “short-chain ester units” as applied to units in a polymer chain of the copolyetheresters refers to low molecular weight compounds or polymer chain units having molecular weights less than about 550. They are made by reacting a low molecular weight diol or a mixture of diols (MW below about 250) with a dicarboxylic acid to form ester units represented by Formula (II) above.

Included among the low molecular weight diols which react to form short-chain ester units suitable for use for preparing copolyetheresters are acyclic, alicyclic and aromatic dihydroxy compounds. Preferred compounds are diols with 2-15 carbon atoms such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, etc. Especially preferred diols are aliphatic diols containing 2-8 carbon atoms, most especially 1,4-butanediol. Included among the bisphenols which can be used are bis(p-hydroxy)diphenyl, bis(p-hydroxyphenyl)methane, and bis(p-hydroxyphenyl)propane. Equivalent ester-forming derivatives of diols are also useful (e.g., ethylene oxide or ethylene carbonate can be used in place of ethylene glycol). The term “low molecular weight diols” as used herein should be construed to include such equivalent ester-forming derivatives; provided, however, that the molecular weight requirement pertains to the diol and not to its derivatives.

Dicarboxylic acids which are reacted with the foregoing long-chain glycols and low molecular weight diols to produce the copolyetheresters are aliphatic, cycloaliphatic or aromatic dicarboxylic acids of a low molecular weight, i.e., having a molecular weight of less than about 300. The term “dicarboxylic acids” as used herein includes acid equivalents of dicarboxylic acids having two functional carboxyl groups which perform substantially like dicarboxylic acids in reaction with glycols and diols in forming copolyetherester polymers. These equivalents include esters and ester-forming derivatives, such as acid halides and anhydrides. The molecular weight requirement pertains to the acid and not to its equivalent ester or ester-forming derivative. Thus, an ester of a dicarboxylic acid having a molecular weight greater than 300 or an acid equivalent of a dicarboxylic acid having a molecular weight greater than 300 are included provided the acid has a molecular weight below about 300. The dicarboxylic acids can contain any substituent groups or combinations which do not substantially interfere with the copolyetherester polymer formation and use of the polymer in the compositions of this invention.

The term “aliphatic dicarboxylic acids”, as used herein, means carboxylic acids having two carboxyl groups each attached to a saturated carbon atom. If the carbon atom to which the carboxyl group is attached is saturated and is in a ring, the acid is cycloaliphatic. Aliphatic or cycloaliphatic acids having conjugated unsaturation often cannot be used because of homopolymerization. However, some unsaturated acids, such as maleic acid, can be used.

Aromatic dicarboxylic acids, as the term is used herein, are dicarboxylic acids having two carboxyl groups attached to a carbon atom in a carbocyclic aromatic ring structure. It is not necessary that both functional carboxyl groups be attached to the same aromatic ring and where more than one ring is present, they can be joined by aliphatic or aromatic divalent radicals or divalent radicals such as —O— or —SO₂—.

Representative aliphatic and cycloaliphatic acids which can be used are sebacic acid, 1,3-cyclohexane dicarboxylic acid, 1,4-cyclohexane- dicarboxylic acid, adipic acid, glutaric acid, 4-cyclohexane-1,2-dicarboxylic acid, 2-ethylsuberic acid, cyclopentanedicarboxylic acid decahydro-1,5-naphthylene dicarboxylic acid, 4,4,′-bicyclohexyl dicarboxylic acid, decahydro-2,6-naphthylene dicarboxylic acid, 4,4,′-methylenebis(cyclohexyl) carboxylic acid, 3,4-furan dicarboxylic acid. Preferred acids are cyclohexane-dicarboxylic acids and adipic acid.

Representative aromatic dicarboxylic acids include phthalic, terephthalic and isophthalic acids, bibenzoic acid, substituted dicarboxy compounds with two benzene nuclei such as bis(p-carboxyphenyl)methane, p-oxy-1,5-naphthalene dicarboxylic acid, 2,6-naphthalene dicarboxylic acid, 2,7-naphthalene dicarboxylic acid, 4,4,′-sulfonyl dibenzoic acid and C₁-C₁₂ alkyl and ring substitution derivatives thereof, such as halo, alkoxy, and aryl derivatives. Hydroxyl acids such as p-(beta-hydroxyethoxy)benzoic acid can also be used providing an aromatic dicarboxylic acid is also present.

Aromatic dicarboxylic acids are a preferred class for preparing the copolyetherester polymers useful for this invention. Among the aromatic acids, those with 8-16 carbon atoms are preferred, particularly terephthalic acid alone or with a mixture of phthalic and/or isophthalic acids.

The copolyetheresters contain about 25-80 weight percent short-chain ester units corresponding to Formula (II) above, the remainder being long-chain ester units corresponding to Formula (I) above. When the copolyetheresters contain less than about 25 weight percent short-chain ester units, then the crystallization rate becomes very slow and the copolyetherester is tacky and difficult to handle. When more than about 80 weight percent short-chain ester units are present, then the copolyetheresters generally become too stiff. The copolyetheresters preferably contain about 30-60, preferably about 40-60, weight percent short-chain ester units the remainder being long-chain ester units. In general, as percent short-chain ester units in the copolyetherester are increased, the polymer has a higher tensile strength and modulus, and the moisture vapor transmission rate decreases. Most preferably, at least about 70% of the groups represented by R in Formulae (I) and (II) above are 1,4-phenylene radicals and at least about 70% of the groups represented by D in Formula (II) above are 1,4-butylene radicals and the sum of the percentages of R groups which are not 1,4-phenylene radicals and D groups which are not 1,4-butylene radicals does not exceed 30%. If a second dicarboxylic acid is used to make the copolyetherester, isophthalic acid is the acid of choice and if a second low molecular weight diol is used, 1,4-butenediol or hexamethylene glycol are the diols of choice.

A blend or mixture of two or more copolyetherester elastomers can be used. The copolyetherester elastomers used in the blend need not on an individual basis come within the values disclosed herein before for the elastomers. However, the blend of two or more copolyetherester elastomers must conform to the values described herein for the copolyetheresters on a weighted average basis. For example, in a mixture that contains equal amounts of two copolyetherester elastomers, one copolyetherester can contain 60 weight percent short-chain ester units and the other copolyetherester can contain 30 weight percent short-chain ester units for a weighted average of 45 weight percent short-chain ester units.

The MVTR of the copolyetheresters can be regulated by various means. The thickness of a layer of copolyetherester has an effect on the MVTR in that the thinner the layer, the higher the MVTR. An increase in the percent of short-chain ester units in the copolyetherester results in a decrease in the MVTR, but also results in an increase in the tensile strength of the layer due to the fact the polymer is more crystalline.

The Young's moduli of the copolyetherester elastomers preferably are from 1000 to 14,000 psi, usually 2000 to 10,000 psi, as determined by ASTM Method D-412. The modulus can be controlled by the ratio of short-chain segments to long-chain segments of the copolyetherester elastomer, and co-monomer choice for preparation of the copolyetherester. Copolyetheresters having a relatively low modulus generally confer better stretch recovery and aesthetics to the laminate structure where the stiffness and drape of the structure are important.

Preferably, the copolyetherester elastomers are prepared from esters or mixtures of esters of terephthalic acid and isophthalic acid, 1,4-butanediol and poly(tetramethylene ether)glycol or ethylene oxide-capped polypropylene oxide glycol, or are prepared from esters of terephthalic acid, e.g. dimethylterephthalate, 1,4-butanediol and poly(ethylene oxide)glycol. More preferably, the copolyetherester elastomers are prepared from esters of terephthalic acid, e.g. dimethylterephthalate, 1,4-butanediol and poly(ethylene oxide)glycol.

The dicarboxylic acids or their derivatives and the polymeric glycol are incorporated into the final product in the same molar proportions as are present in the reaction mixture. The amount of low molecular weight diol actually incorporated corresponds to the difference between the moles of diacid and polymeric glycol present in the reaction mixture. When mixtures of low molecular weight diols are employed, the amounts of each diol incorporated are largely a function of the amounts of the diols present, their boiling points, and relative reactivities. The total amount of glycol incorporated is still the difference between moles of diacid and polymeric glycol. The copolyetherester elastomers described herein can be made conveniently by a conventional ester interchange reaction. A preferred procedure involves heating the ester of an aromatic acid, e.g., dimethyl ester of terephthalic acid, with the poly(alkylene oxide)glycol and a molar excess of the low molecular weight diol, 1,4-butanediol, in the presence of a catalyst at 150°-160° C., followed by distilling off methanol formed by the interchange reaction. Heating is continued until methanol evolution is complete. Depending on temperature, catalyst and glycol excess, this polymerization is complete within a few minutes to a few hours. This product results in the preparation of a low molecular weight prepolymer which can be carried to a high molecular weight copolyetherester by the procedure described below. Such prepolymers can also be prepared by a number of alternate esterification or ester interchange processes; for example, the long-chain glycol can be reacted with a high or low molecular weight short-chain ester homopolymer or copolymer in the presence of catalyst until randomization occurs. The short-chain ester homopolymer or copolymer can be prepared by ester interchange from either the dimethyl esters and low molecular weight diols as above, or from the free acids with the diol acetates. Alternatively, the short-chain ester copolymer can be prepared by direct esterification from appropriate acids, anhydrides or acid chlorides, for example, with diols or by other processes such as reaction of the acids with cyclic ethers or carbonates. Obviously the prepolymer might also be prepared by running these processes in the presence of the long-chain glycol.

The resulting prepolymer is then carried to high molecular weight by distillation of the excess of short-chain diol. This process is known as “polycondensation”. Additional ester interchange occurs during this distillation to increase the molecular weight and to randomize the arrangement of the copolyetherester units. Best results are usually obtained if this final distillation or polycondensation is run at less than 1 mm pressure and 240°-260° C. for less than 2 hours in the presence of antioxidants such as 1,6-bis-[(3,5-di-tert-butyl-4-hydroxyphenol)propionamido]-hexane or 1,3,5-trimethyl-2,4,6-tris[3,5-ditertiary-butyl-4-hydroxybenzyl]benzene. Most practical polymerization techniques rely upon ester interchange to complete the polymerization reaction. In order to avoid excessive hold time at high temperatures with possible irreversible thermal degradation, it is advantageous to employ a catalyst for ester interchange reactions. While a wide variety of catalysts can be used, organic titanates such as tetrabutyl titanate used alone or in combination with magnesium or calcium acetates are preferred. Complex titanates, such as derived from alkali or alkaline earth metal alkoxides and titanate esters are also very effective. Inorganic titanates, such as lanthanum titanate, calcium acetate/antimony trioxide mixtures and lithium and magnesium alkoxides are representative of other catalysts which can be used.

Ester interchange polymerizations are generally run in the melt without added solvent, but inert solvents can be used to facilitate removal of volatile components from the mass at low temperatures. This technique is especially valuable during prepolymer preparation, for example, by direct esterification. However, certain low molecular weight diols, for example, butanediol, are conveniently removed during polymerization by azeotropic distillation. Other special polymerization techniques for example, interfacial polymerization of bisphenol with bisacylhalides and bisacylhalide capped linear diols, may be useful for preparation of specific polymers. Both batch and continuous methods can be used for any stage of copolyetherester polymer preparation. Polycondensation of prepolymer can also be accomplished in the solid phase by heating finely divided solid prepolymer in a vacuum or in a stream of inert gas to remove liberated low molecular weight diol. This method has the advantage of reducing degradation because it must be used at temperatures below the softening point of the prepolymer. The major disadvantage is the long time required to reach a given degree of polymerization.

Although the copolyetheresters possess many desirable properties, it is sometimes advisable to stabilize these compositions further against heat or light produced degradation. This is readily achieved by incorporating stabilizers in the copolyetherester compositions. Satisfactory stabilizers comprise phenols, especially hindered phenols and their derivatives, amines and their derivatives, especially arylamines.

Representative phenol derivatives useful as stabilizers include 4,4,′-bis(2,6-di-tertiarybutylphenol); 1,3,5-trimethyl-2,4,6-tris[3,5-ditertiary-butyl-4-hydroxybenzyl]benzene and 1,6-bis[(3,5-di-tert-butyl-4-hydroxyphenyl)propionamido]hexane. Mixtures of hindered phenols with co-stabilizers such as diaurylthiodipropionate or phosphites are particularly useful. Improvement in light stability occurs by the addition of small amounts of pigments or the incorporation of a light stabilizer, such as benzotriazole ultraviolet light absorbers. The addition of hindered amine photostabilizers, such as bis(1,2,2,6,6-pentamethyl-4-piperidinyl) n-butyl-(3,5-di-tert-butyl-4-hydroxybenzyl)malonate, usually in amounts of from 0.05-1.0% by weight of the copolyetherester, are particularly useful in preparing compositions having resistance to photodegradation.

To prepare a laminated fabric, the fabric and film or coating are first prepared, then laminated together or coated one onto the other.

The fabric is usually woven or knit and then scoured, dyed, and heat set prior to lamination. Scouring removes size and spinning finish deposits, though careful choice of suitable adhesives or spinning finishes can render this step unnecessary.

Films are prepared by conventional casting or extrusion processes. Films may also be blown.

The elastomeric film can be directly laminated onto the fabric substrate or an adhesive can be employed to enhance the bond between the elastomeric film and the fabric substrate. Suitable adhesives include polyurethanes, polyetherurethanes, ethylene copolymers, and silicones. A suitable polyurethane adhesive is available from Henkel under the trademark Liofol®. A suitable ethylene copolymer adhesive is available from DuPont under the trademark Bynel®. The adhesive is preferably applied at a rate of 5 to 100 g/m², and may be disposed between the fabric substrate and the elastomeric film by any conventional method. The adhesive may be coextruded onto the fabric substrate together with the elastomeric film. The adhesive may be a heat curing, moisture curing, time curing, solvent-based, or hot melt adhesive, or it may take another known form of adhesive or binder, and it may be single or multi-component. In the case of multi-component adhesives, the components which must be brought together to effect curing may be coated separately onto the film and fabric substrate if desired in order to prolong working life.

Lamination may be achieved in a variety of ways. Adhesive may be coated onto the fabric or onto the film or both using a knife over air or a knife over roller process, or alternatively may be sprayed or printed onto the fabric or applied using any known process. Typically, the adhesive will be applied as a discontinuous film. The temperature of the adhesive during the process should be chosen to generate an appropriate viscosity and, if the adhesive is cured, an appropriate rate of cure.

Following application of the adhesive, the fabric substrate and the elastomeric film are brought together and pressure is applied using a roll or series of rolls, pressure pad, bar or other device, and the resulting laminate is allowed to form into a coherent structure. Any necessary cure process can then be performed.

Other commercial manufacturing processes such as coating are also commonly used.

After lamination or coating, a Teflon® finish may be applied to the layered composite fabric in order to impart water repellency.

By “garment” is meant an item of clothing, such as a jacket, poncho, shirt, or pair of pants, and also includes accessories such as gloves, mittens, hats, hosiery, or footwear, all of which are worn as an outer layer. The garment typically is worn to provide weather protection from moisture, such as water, rain, snow or other types of precipitation. With the appropriate film or coating, the garment could also be used to provide protection from microbes, such as viruses and bacteria.

The garment produced from the layered composite fabric can be of conventional or original design. In the preferred embodiment, substantially all parts of the garment, such as threads, seam tapes, laces, drawstrings, drawstring stops, fasteners, buttons, linings, insulation, pads, and optional other accessories are comprised substantially of the same polymer as the fabric in order to simplify recycling of the garment. In the most preferred embodiment, substantially all parts of the garment and the fabric are comprised substantially of polyester.

A combination of fabric layers can be used to make a complete, finished garment. Typical fabric system constructions include a two layer face fabric (where the face fabric is laminated to the film), a two layer lining fabric (where the lining fabric is laminated to the film), a three layer fabric (where typically the face fabric is laminated to the film, and the lining fabric is then laminated to the back side of the film), and a drop lining. In such constructions, all the components are loosely assembled into the garment with the film typically being bonded to a lightweight non-woven to give it structural support. In another embodiment, the fabric is coated with molten or dissolved elastomeric film instead of being laminated to the film. The garment can also include other functional layers, such as insulation or batting.

The fabric or garment disclosed herein can be recycled by conventional means. A polyester fabric or a polyester garment can be shredded, or otherwise converted into smaller pieces, then melted and reprocessed to obtain polyester polymer. Alternatively, the shredded polyester fabric or garment may be subjected to a method to depolymerize the polyester and recover its monomeric components, such as methanolysis. A polyamide fabric or garment could also be shredded, then melted and reprocessed to obtain polyamide polymer. The polyamide fabric or garment could also be depolymerized to one or more monomers by such methods as acid- or base-catalyzed depolymerization, ammonolysis, or treatment with a monocarboxylic acid.

### Test Methods

Waterproofness of textile fabrics is determined by the well-established standard test method ISO 811. This test involves applying a hydrostatic head (water column) to a small (100 cm²) fabric sample. The fabric sample is subjected to a steadily increasing pressure of water on one face, under standard conditions, until water penetration occurs in three places. The pressure (mm) at which the water penetrates the fabric at the third place is noted. As shown in Table I below, water pressures for layered fabrics are at a minimum greater than 1,000 mm and preferably greater than 10,000 mm. Full details of how to perform measurements with this method are given in ISO 811.

An objective measure of absolute breathability can be obtained with the standard test method ISO 11092, which specifies methods for the measurement of the thermal resistance and water-vapor resistance, under steady-state conditions, for items such as fabrics, films, coatings, and multilayer assemblies for clothing and other uses. For the determination of water-vapor resistance (also referred to as resistance to evaporative transmission), an electrically heated porous plate is covered by a water-vapor permeable but liquid-water impermeable membrane. Water fed to the heated plate evaporates and passes through the membrane as vapor, so that no liquid water contacts the test specimen. With the sample on the membrane, the heat flux required to maintain a constant temperature at the plate is a measure of the rate of water evaporation, and from this the water-vapor resistance (M^{2·}Pa/W) of the test specimen is determined. As illustrated in Table I, the water-vapor resistance for layered composite fabrics of the present invention is typically less than 36 M^{2·}Pa/W and preferably between 2 and 20 M^{2·}Pa/W for fabrics having a two-layer construction and between 5 and 30 M^{2·}Pa/W for fabrics having a three-layer construction. Full details of how to perform measurements with this method are given in ISO 11092.

Moisture vapor transmission rate (MVTR), standardized as ISO 15496, is determined according to ASTM Standard E96-66, Procedure BW (Inverted Water Method at 23° C.). Standard E96-66 permits determination of the rate of water vapor transmission of materials in sheet form calculated as g/(m^{2·}/24 h). Procedure BW is for use when materials to be tested may in service be wetted on one surface, but under conditions where the hydraulic head is relatively unimportant and moisture is governed by capillary and water vapor diffusion forces. As shown in Table I, MVTR rates of the present invention are typically greater than 500 g/(m^{2·}24 h), and preferably between 4,000 and 10,000 g/(m^{2·}24 h) for 2-layered composite fabrics and preferably between 2,000 and 4,500 g/(m^{2·}24 h) for 3-layered composite fabrics. Full details of how to perform measurements with this method are given in ASTM Standard E96-66.

Fabric stretch and recovery for a stretch woven fabric is determined using a universal electromechanical test and data acquisition system to perform a constant rate of extension tensile test. A suitable electromechanical test and data acquisition system is available from Instron Corp, 100 Royall Street, Canton, Mass., 02021 USA. Two fabric properties are measured using this instrument: fabric stretch (TTM 076) and the fabric growth (TTM 077) (deformation). The available fabric stretch is the amount of elongation caused by a specific load between 0 and 30 Newtons and expressed as a percentage change in length of the original fabric specimen as it is stretched at a rate of 300 mm per minute. The fabric growth is the unrecovered length of a fabric specimen which has been held at 80% of available fabric stretch for 30 minutes then allowed to relax for 60 minutes. Where 80% of available fabric stretch is greater than 35% of the fabric elongation, this test is limited to 35% elongation. The fabric growth is then expressed as a percentage of the original length. The elongation or maximum stretch of stretch woven fabrics in the stretch direction is determined using a three-cycle test procedure. The maximum elongation measured is the ratio of the maximum extension of the test specimen to the initial sample length found in the third test cycle at load of 30 Newtons. This third cycle value corresponds to hand elongation of the fabric specimen.

The minimum and preferred range values for the properties displayed by the layered composite fabrics of the present invention are summarized in Table I below.

TABLE I

| Fabric Property | | | | Minimum Values | | Preferred Values | |
|---|---|---|---|---|---|---|---|
| Initial Properties | | Method | Units | 2-layer | 3-layer | 2-layer | 3-layer |
| Stretch & | | | | | | | |
| Recovery: | | | | | | | |
| Fabric Elongation | — | TTM076 | % | >1 | >1 | 5 to | 5 to |
| | | | | | | 200 | 200 |
| Growth & | | TTM077 | % | <1 | <1 | <1 | <1 |
| Recovery | | | | | | | |
| (Deformation) | | | | | | | |
| Breathability: | | | | | | | |
| Ret | — | ISO 11092 | m² · Pa/W | <36 | <36 | 2 to 20 | 5 to 30 |
| MVTR | | ISO 15496 | g/(m² · 24 h) | >500 | >500 | 4000 to | 2000 to |
| | | | | | | 10000 | 4500 |
| Waterproofness: | | | | | | | |
| Hydrohead | — | ISO 811 | mm | >1000 | >1000 | >10000 | >10000 |
| | Washing & | | | | | | |
| Properties after | Drying | | | | | | |
| washing & drying | Procedure | | | | | | |
| Waterproofness: | | | | | | | |
| Hydrohead | ISO 6330- | ISO 811 | mm | >1000 | >1000 | >3000 | >10000 |
| | 6A-A | | | | | | |
| | (20 cycles) | | | | | | |
| Hydrohead | ISO 6330- | ISO 811 | mm | >1000 | >1000 | >3000 | >10000 |
| | 7B-E50 | | | | | | |
| | (20 cycles) | | | | | | |

1. A recyclable, waterproof, layered composite fabric with stretch, comprising:
(a) at least one fabric layer comprising from about 1% to 100% by weight of bicomponent fibers; and
(b) an elastomeric coating or film on or adjacent to said fabric layer;
wherein no separation step is required to recycle said layered composite fabric as a source of recyclable polyester or polyamide.

2. The layered composite fabric of claim 1 wherein said bicomponent fibers are polyester.

3. The layered composite fabric of claim 1 wherein one or more of said bicomponent fibers are copolyesters.

4. The layered composite fabric of claim 1 wherein said elastomeric coating is a copolyetherester having a multiplicity of recurring long-chain ester units and short-chain ester units joined head to tail through ester linkages.

5. The layered composite fabric of claim 1, wherein said elastomeric coating or film comprises a material selected from the group consisting of: polyester, polyamide, copolyester and copolyamide.

6. The layered composite fabric of claim 1, wherein the bicomponent fibers are polyester bicomponent fibers and the elastomeric coating or film comprises a copolyetherester elastomeric coating having a multiplicity of recurring long-chain ester units and short-chain ester units joined head to tail through ester linkages, wherein said long-chain ester units are represented by the formula: 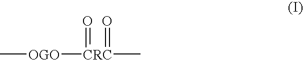
and said short-chain ester units are represented by the formula: 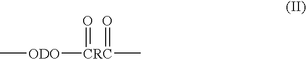
wherein:
a) G is a divalent radical, remaining after the removal of terminal hydroxyl groups from compounds selected from the group consisting of poly(ethylene oxide)glycol, ethylene-oxide capped polypropylene oxide glycol, or a mixture of poly(ethylene oxide)glycol with ethylene oxide capped poly(propylene oxide)glycol and/or poly(tetramethylene oxide)glycol;
b) R is a divalent radical, remaining after removal of carboxyl groups, from compounds selected from the group consisting of isophthalic acid, sebacic acid, 1,3-cyclohexane dicarboxylic acid, 1,4-cyclohexane dicarboxylic acid, adipic acid, glutaric acid, 4-cyclohexane-1,2-dicarboxylic acid, 2-ethylsuberic acid, cyclopentane dicarboxylic acid, decahydro-1,5-naphthylene dicarboxylic acid, 4,4′,-bicyclohexyl dicarboxylic acid, decahydro-2,6-naphthylene dicarboxylic acid, 4,4′,-methylenebis(cyclohexyl) carboxylic acid, and 3,4-furan dicarboxylic acid phthalic acid, terephthalic acid, dibenzoic acid, bis(p-carboxyphenyl)methane, p-oxy-1,5-naphthalene dicarboxylic acid, 2,6-naphthalene dicarboxylic acid, 2,7-naphthalene dicarboxylic acid, and 4,4′-sulfonyl dibenzoic acid;
c) D is a divalent radical remaining after removal of hydroxyl groups from diol compounds selected from the group consisting of ethylene diol, propylene diol, isobutylene diol, tetramethylene diol, 1,4-pentamethylene diol, 2,2-dimethyltrimethylene diol, hexamethylene diol, dihydroxycyclohexane, cyclohexane dimethanol, resorcinol, hydroquinone, 1,5-dihydroxynaphthalene, 1,4-butanediol, bis(p-hydroxy)diphenyl, bis(p-hydroxyphenyl)methane, or bis(p-hydroxyphenyl)propane; and wherein said layered composite fabric is sufficiently free of auxiliary materials such that no separation step is required to recycle said layered composite fabric as a source of polyester.

7. The layered composite fabric of claim 1, wherein the bicomponent fibers are polyester bicomponent fibers, and the elastomeric waterproof film or coating comprises polyester, and wherein said layered composite fabric is sufficiently free of non-polyester components such that no separation step is required to recycle said layered composite fabric as a source of recyclable polyester.

8. The layered composite fabric of claim 1 having a fabric elongation greater than about 1%; a fabric deformation of less than about 1%; a water-vapor resistance of less than about 36 M^{2·}Pa/W; an MVTR of at least about 500 g/(m^{2·}24 h) ; and a water penetration pressure of more than about 1000 mm.

9. The layered composite fabric of claim 1 having a fabric elongation of between about 5 and 200%; a fabric deformation of less than about 1%; a water-vapor resistance of between about 2 and 20 M^{2 ·}Pa/W; an MVTR of between about 4,000 and 10,000 g/(m^{2·}24 h); and a water penetration pressure of more than about 10,000 mm.

10. The layered composite fabric of claim 1 having a fabric elongation of between about 5 and 200%; a fabric deformation of less than about 1%; a water-vapor resistance of between about 5 and 30 M^{2 ·}Pa/W; an MVTR of between about 2,000 and 4,500 g/(m^{2·}24 h) ; and a water penetration pressure of more than about 10,000 mm.

11. A garment comprising the layered composite fabric of claim 1.

12. The garment of claim 11, further comprising a liner fabric of knitted, woven or nonwoven construction comprising a recyclable polymer.

13. The garment of claim 11, wherein said bicomponent fibers are polyamide.

14. The garment of claim 11, wherein said bicomponent fibers are polyester.

15. A garment comprising the layered composite fabric of claim 8.

16. A garment comprising the layered composite fabric of claim 1 wherein said elastomeric coating is a copolyetherester.

17. A recyclable, waterproof, breathable, layered composite fabric with stretch, comprising:
(a) at least one fabric layer of woven, knitted or non-woven construction comprising from about 1% to 100% by weight of stretch-recovery polyamide bicomponent fibers, and
(b) an elastomeric waterproof film or coating comprising polyamide;
wherein said layered composite fabric is sufficiently free of non-polyamide components such that no separation step is required to recycle said layered composite fabric as a source of recyclable polyamide.

18. A recyclable, waterproof, breathable garment with stretch comprising the layered composite fabric of claim 17, and further comprising a liner fabric of knitted, nonwoven or woven construction comprising polyamide.
